(19) United States
(12) Patent Application Publication
(10) Pub. No.: US 2009/0035963 A1
(43) Pub. Date: Feb. 5, 2009

(54) Semiconductor device socket

(75) Inventor: Nobuo Kawamura, Sakura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAMAICHI ELECTRONICS CO., LTD.

(21) Appl. No.: 12/222,108

(22) Filed: Aug. 1, 2008

(30) Foreign Application Priority Data
Aug. 2, 2007 (JP) 2007-202202

(51) Int. Cl. H01R 12/14

(52) U.S. Cl. 439/78

(57) ABSTRACT

A fixed side terminal of a contact terminal having a movable side contact piece and a fixed side contact piece has a contact portion in contact with a group of electrodes of a printed wiring board at a predetermined pressure, and a socket body is fixed to the printed wiring board via locking nibs fastened by a tapping screw.

### CROSS-REFERENCE TO RELATED APPLICATIONS AND INCORPORATION BY REFERENCE

This application claims the benefit of Japanese Patent Application No. 2007-202202, filed Aug. 2, 2007, which is hereby incorporated by reference herein in its entirety.

### BACKGROUND OF THE INVENTION

1. Field of the Invention

The present invention relates to a semiconductor device socket for electrically connecting a semiconductor device, to be tested, to a printed wiring board.

2. Description of the Related Art

For removing latent defects of a semiconductor device to be mounted to electronic equipment at a stage prior to being actually mounted, a burn-in test is generally carried out through a semiconductor device socket. Such test is believed effective for removing infant mortality failures in integrated circuits.

The semiconductor device socket made available for such a test is generally referred to as an IC socket, and, as described, for example, in Japanese Patent Laid-Open No. 2004-355983, is arranged on a printed wiring board (test board). The printed wiring board has an input/output section supplied with a predetermined test voltage and supplies an abnormality signal representing, for example, a short-circuit, from the semiconductor device as an object to be tested. At that time, a body of the IC socket is fastened, for example, by mounting screws and nuts via a plurality of mounting bores provided in the printed wiring board. There may be cases where a plurality of IC sockets are arranged on a single printed wiring board at a high density for the purpose of improving the test efficiency in a test line.

Such an IC socket has, in the interior of a socket body, a group of contact terminals for electrically connecting the terminals of the semiconductor device to the input/output section in the printed wiring board. Fixed terminal portions of the respective contact terminals constituting a group of contact terminals are generally soldered and fixed to the respective plated through-holes of the printed wiring board.

### SUMMARY OF THE INVENTION

As described above, when a plurality of IC sockets are arranged on a single printed wiring board at a high density, there is a problem when a malfunction occurs in one of the IC sockets. When such a problem occurs, the printed wiring board becomes unusable during a predetermined period due to maintenance or the replacement of the problem IC socket.

In such a case, in order to continue the test without interrupting the operation of the inspection line for a relatively long period, it is possible to have a spare test board with the same IC sockets ready for use.

However, maintaining a spare test board is inadvisable since the installation cost for the inspection line increases. Also, the soldering operation of the fixed terminal portion consumes a relatively long time for replacement and it may cause the breakage of the test board. Such breakage decreases the yield. As a consequence, it is desirable to eliminate the soldering operation and, instead, quickly replace the problem IC socket solely by a simple operation.

In view of the above-described problem, the present invention aims to provide a semiconductor device socket for electrically connecting a semiconductor device to be tested to a printed wiring board. The semiconductor device socket can be replaced by a simple operation in a short time.

To achieve the above-described object, a semiconductor device socket according to the present invention comprises a socket body having a semiconductor device accommodation part for detachably housing the semiconductor device, the socket body provided on a printed wiring board having an electrode surface forming a group of electrodes; a contact terminal arranged in the semiconductor device accommodation part, having a pair of elastic contact pieces for selectively nipping terminals of the semiconductor device, and a fixed side terminal formed continuous to the contact piece to be elastically deformable in a direction generally perpendicular to the electrode surface of the printed wiring board to touch the electrode surface, the contact terminal electrically connecting the terminal of the semiconductor device to the electrode surface of the printed wiring board; a slider member having a pressing portion for moving one or both of the contact pieces of the contact terminal so that one of the contact pieces of the contact terminal moves to the other of the contact pieces relatively closer or further away, and a cover member movably supported by the socket body for operating the pressing portion of the slider member in accordance with the attachment/detachment of the semiconductor device relative to the semiconductor device accommodation part so that the pair of contact pieces of the contact terminal is in contact with or displaced from the terminal of the semiconductor device.

According to the semiconductor device socket of the present invention, the terminal of the semiconductor device is electrically connected to the electrode surface of the printed wiring board via the pair of elastic contact pieces provided in the contact terminal for selectively nipping the terminal of the semiconductor device and the fixed side terminal formed continuously to the contact piece to be elastically deformable perpendicular to the electrode surface of the printed wiring board. As a result, a soldering operation carried out in the printed wiring board is unnecessary, and only the broken IC socket can be easily replaced by a simple operation in a short time.

Further features of the present invention will become apparent from the following description of exemplary embodiments (with reference to the attached drawings).

### BRIEF DESCRIPTION OF THE DRAWINGS

FIG. 1 is an enlarged partial sectional view showing a main part in one embodiment of a semiconductor device socket according to the present invention;

FIG. 2 is a front view illustrating an appearance of the embodiment of the semiconductor device socket according to the present invention;

FIG. 3 is a plan view of the embodiment shown in FIG. 2;

FIG. 4 is a side view of the embodiment shown in FIG. 2;

FIG. 5 is a partial sectional view of the embodiment shown in FIG. 2;

FIG. 6 is a partial enlarged sectional view made available for explaining the fastening operation of a locking nib in the embodiment shown in FIG. 2; and

FIG. 7 is a partial sectional view illustrating another example of a contact terminal and a printed wiring board used in the embodiment of the semiconductor device socket according to the present invention.

### DETAILED DESCRIPTION OF THE INVENTION

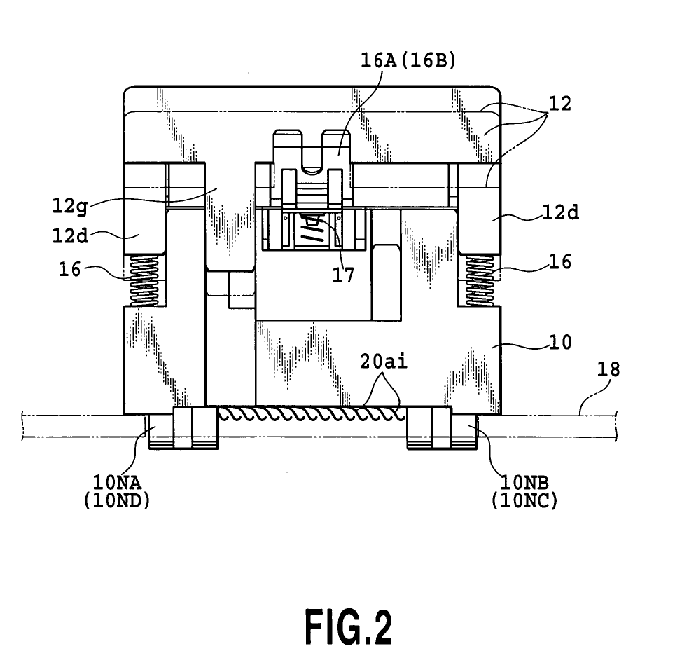

FIG. 2 illustrates one embodiment of a semiconductor device socket according to the present invention together with a printed wiring board used as a test board. In this regard, in FIG. 2, only one of a plurality of semiconductor device sockets arranged on the printed wiring board is shown as a representative socket.

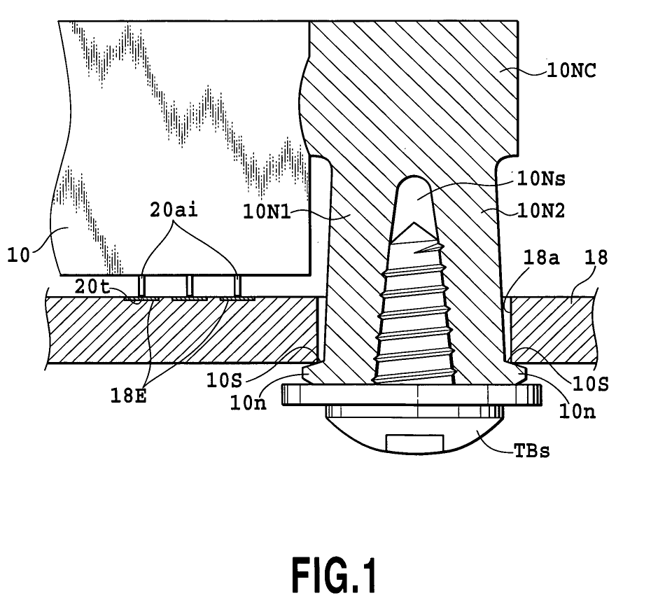

Each of the semiconductor device sockets is arranged at predetermined positions in a conductive pattern formed on a printed wiring board 18 having a predetermined thickness. In such positions of the conductive pattern, as enlarged in FIG. 1, a group of electrodes 18E are formed in contact with contact portions in fixed side terminals of contact terminals described later. Also, on the periphery of the conductive pattern, a generally rectangular bore 18a (see FIG. 1) is formed for receiving a respective fixing nib described later. Note that the shape of the bore 18a is not be limited to this example but may be other shapes such as circular.

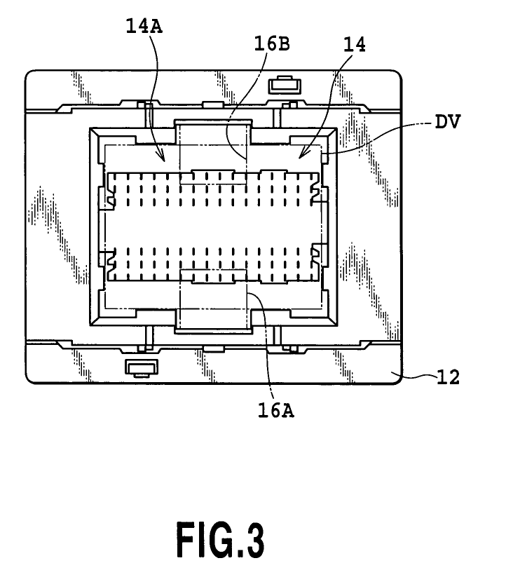

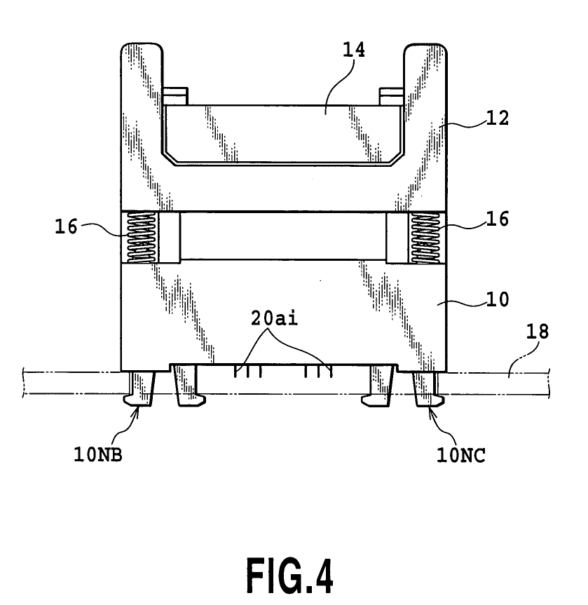

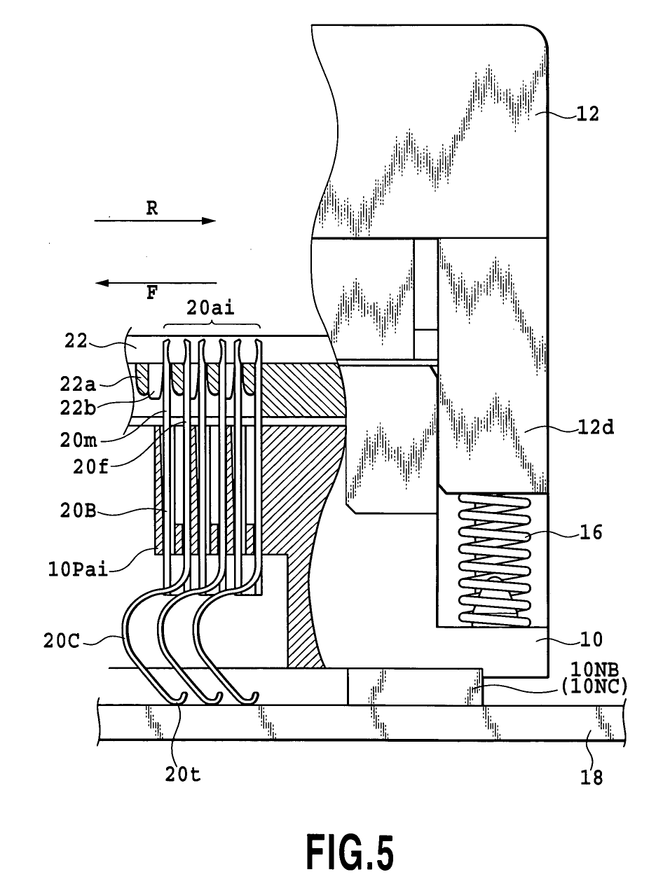

As shown in FIGS. 2 and 4, the semiconductor device socket includes, as main elements, a socket body 10 fixed on the above-described printed wiring board 18, a plurality of contact terminals 20ai (i=1 to n, n is a positive integer) provided in a contact accommodating part located at a center of the socket body 10. The contact terminals electrically connect a semiconductor device described later to the conductive pattern of the printed wiring board 18. A cover member 12 is held on the socket body 10 so as to be vertically movable for transmitting an operating force to a latch mechanism described later. A slider member 22 (see FIGS. 3 and 5) is provided with a positioning part 14 for detachably accommodating the semiconductor device DV and positioning the electrodes of the semiconductor device DV relative to the contact terminals of an electrode section. Further, a latch mechanism includes pressing members 16A and 16B for pressing the respective electrode sections of the semiconductor device DV accommodated in the positioning part 14 toward a plurality of contact terminals and holding the semiconductor device DV.

The semiconductor device DV to be inserted the semiconductor device socket is, for example, a generally square-shaped BGA-type semiconductor device including an electrode surface having a plurality of spherical electrodes arranged lengthwise and crosswise.

The socket body 10 is made of resinous material and has recesses (not shown) at opposite ends thereof. The recesses slidably receive a lower end of an arm portion and proximal ends of the opposite ends of the pressing members 16A and 16B when the cover member 12 is moved downward. Also, as shown in FIG. 5, in a middle portion of the interior of the socket body 10, a contact accommodation part is formed wherein a plurality of contact terminals 20ai are arranged in correspondence to the electrode section of the semiconductor device DV.

The contact accommodation part comprises a recess opening to a surface of the printed wiring board 18 and a plurality of cells communicating with the recess, cells for housing the contact terminals 20ai, respectively. The respective cells are formed lengthwise and crosswise at a predetermined gap between adjacent ones. A partitioning wall 10Pai (i=1 to n, n is a positive integer) is provided between the adjacent cells. There is a press-fit part for holding the fixed portion 20B of the contact terminal 20ai by the inner wall surface in the interior of the cell. On the upper side of the contact accommodation part which opens to the opening end of the cell, a flat surface is formed. On the flat surface, a slider member 22 described later is arranged in a movable manner.

The contact terminal 20ai is integrally formed of elastic sheet metal by press working and extends generally perpendicular to the surface of the printed wiring board 18. The contact terminal 20ai comprises a movable side contact piece 20m and a fixed side contact piece 20f, to form a pair of contacts, for selectively nipping the spherical electrode(s) of the semiconductor device DV described before, a fixed side terminal 20C having a contact portion 20t in contact with an electrode constituting the group of electrodes 18E in the printed wiring board 18, and a fixed portion 20B for coupling the movable side contact piece 20m and the fixed side contact piece 20f with the fixed side terminal 20C.

In FIG. 5, the movable side contact piece 20m has an elasticity that permits the contact piece 20m to be close to or spaced from the fixed side contact piece 20f. At upper ends of the movable side contact piece 20m and the fixed side contact piece 20f, there are contact portions in contact with the spherical electrode of the semiconductor device DV. The respective contact portion projects through a slit 22b of the slider member 22 to a position in the vicinity of the positioning part 14.

In FIG. 5, when the slider member 22 is moved in the direction indicated by an arrow F, the contact portion of the movable side contact piece 20m is pressed by a pressing portion 22a of the slider member 22 to be moved to a remote position away from a contact portion of the fixed side contact piece 20f. On the other hand, when the slider member 22 is moved in the direction indicated by an arrow R and returned to the initial position, the contact portion of the movable side contact piece 20m is closer to the contact portion of the fixed side contact piece 20f.

The fixed side terminal 20C formed in a curved shape is elastic and is coupled to the fixed portion 20B at one end, while the contact portion 20t formed at the other end of the fixed side terminal 20C touches the electrode group 18E of the printed wiring board 18 at a predetermined pressure. Accordingly, the soldering operation between the fixed side terminal 20C of the contact terminal 20ai and the electrode group 18E of the printed wiring board 18 is unnecessary.

The slider member 22 is moved in the direction indicated by the arrow F in FIG. 5 by a cam mechanism (not shown) in correspondence to the downward movement of the cover member 12. The cam mechanism includes a lever member and a coil spring as disclosed, for example, in Japanese Patent Laid-Open No. 2003-17207.

The slider member 22 has slits 22b arranged lengthwise and crosswise, through which pass pairs of the movable side contact piece 20m and the fixed side contact piece 20f. The adjacent slits 22b on the same line are separated from each other by the pressing portion 22a. The adjacent slits 22b on the adjacent different lines are separated from each other by a partitioning wall.

As shown in FIG. 3, the positioning part 14 integrally formed together with the slider member 22 is provided with a semiconductor device accommodation part 14A as a housing the semiconductor device DV, having a guide portion for positioning the electrodes of the semiconductor device DV to the respective contact portions of the contact terminals 20ai. The contact portions of the contact terminals 20ai described above project into the interior of the semiconductor device accommodation part 14A, openings for allowing the pressing members 16A and 16B to pass therethrough, respectively.

The cover member 12 has, at a center thereof, an opening wherein the positioning part 14 of the above-described slider member 14 is movable. When the semiconductor device DV is mounted/dismounted relative to the positioning part 14, the semiconductor device DV passes this opening.

As shown in FIG. 2, the cover member 12 has a plurality of legs 12g which are held by the respective grooves formed on the outer periphery of the socket body 10 and are guided thereby to be vertically movable. In FIG. 2, only one of the legs 12g is illustrated.

Several coil springs 16 bias the cover member 12 away from the socket body 10; that is, upward; are provided between a spring reception part 12d in the cover member 12 and the socket body 10. At that time, a hook provided at a tip end of the leg 12g of the cover member 12 is engaged with an end of the groove. Thereby, as shown in FIG. 2, the cover member 12 is held at the uppermost end position. In this regard, FIGS. 2 and 4 illustrate a state wherein the cover member 12 is held at the uppermost end position.

The cover member 12 has an arm (not shown) for pressing proximal ends of the pressing members 16A and 16B constructing the latch mechanism, when it is moved downward, as indicated in FIG. 2 by a chain double-dashed line.

The pressing members 16A and 16B are supported in a rotatable manner at positions opposed to the respective longer sides of the positioning part 14 in the socket body 10. Also, as shown in FIG. 2, the proximal ends of the pressing members 16A and 16B are biased by coil springs 17, respectively, in a direction to press down the semiconductor device DV mounted in the positioning part 14 by the tip ends thereof. Thereby, the tip ends of the pressing members 16A and 16B are located on the positioning part 14. On the other hand, when the proximal ends of the pressing members 16A and 16B are pressed against the biasing force of the coil springs 17 by the arm of the cover member 12, the tip ends of the pressing members 16A and 16B are located at predetermined waiting positions apart from the positioning part 14.

Further, as shown in FIGS. 2 and 4, on the bottom of the socket body 10, when placed on the surface of the printed wiring board 18, fixing nibs 10NA, 10NB, 10NC and 10ND are integrally formed at four positions so that the fixing nibs 10NA and 10NB (10NC and 10D) are spaced apart from each other at a predetermined distance and the nibs 10NB and 10NC (10NA and 10ND) are spaced apart from each other at another predetermined distance. Since the fixing nibs 10NA, 10NB, 10NC and 10ND have the same structure, a description will be given only for the fixing nib 10NC.

As shown in the enlarged view of FIG. 1, the fixing nib 10NC has bifurcate locking pieces 10N1 and 102 spaced apart from each other along a short side of the socket body 10. A tapered bore 10Ns is formed between the locking pieces 10N1 and 10N2.

The respective locking portions 10n projecting outward from the tip ends of the locking pieces 10N1 and 10N2 are elastically deformable in a direction towards and away from each other. That is, the respective locking portions 10n are movable close to each other to allow them to pass through the bore 18a or apart from each other to be locked on the periphery of the open end of the bore 18a on the lower surface.

The respective locking portion 10n has a slant 10S having a predetermined downward inclination enlarged from the outer surface of the tip end of the locking piece N1. When the locking pieces 10N1 and 10N2 are fixed to the printed wiring board 18, each slant 10S touches the periphery of the open end of the bore 18a formed on the lower surface of the printed wiring board 18.

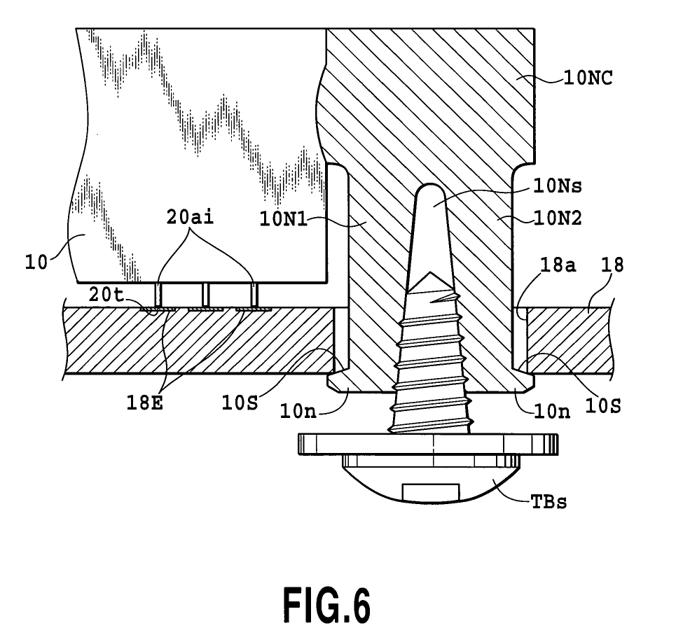

When the fixing nib 10NC is secured in the bore 18a of the printed wiring board 18, first, the locking pieces N1 and N2 are positioned to the bore 18a and, thereafter, the socket body 10 is pressed against the elastic force of the fixed side terminal 20C of the contact terminal 20ai projecting from the bottom of the socket body 10. Thereby, when an end surface of the locking portions 10n of the locking pieces 10N1 and 10N2 touch the periphery of the open end of the bore 18a on the upper surface thereof and are further pressed thereto, they are elastically deformed close to each other, after passing the bore 18a, and elastically deformed spaced apart from each other. Accordingly, as shown in the enlarged view of FIG. 6, the respective slant 10S is brought into contact with the periphery of the open end of the bore 18a formed on the lower surface of the printed wiring board 18. At that time, a tapping screw TBs is threaded into the bore 10Ns.

Next, as shown in the enlarged view of FIG. 1, the tapping screw TBs is threaded into the bore 10Ns. Thereby, the locking portions 10n of the locking pieces 10N1 and 10N2 are further elastically deformed apart from each other, and the socket body 10 is drawn toward the printed wiring board 18 while sliding along the slants 10S. Accordingly, since no gap is formed between the respective slants 10S and the periphery of the bore 18a due to variance of the plate thickness of the printed wiring board 18, a contacting pressure of the fixed side terminal 20C of the contact terminal 20ai that is less than a predetermined value can be avoided.

Upon testing the semiconductor device DV by a tester so constructed, a pressing surface of a pressing member provided in a transfer robot (not shown) is first brought into contact with an upper surface of the cover member 12 and pressed downward at a predetermined stroke against the biasing force of the above-described coil springs 16.

Thereby, the pressing members 16A and 16B are located at waiting positions spaced apart from each other. Also, the semiconductor device DV as an object to be tested is conveyed, while being retained by a transfer arm of the conveyor robot (not shown), to a position directly above the opening of the cover member 12 and the positioning part 14.

Next, the semiconductor device DV retained by vacuum by the transfer arm is lowered through the opening of the cover member 12 to be located in the semiconductor device accommodation part 14A, and mounted there. Subsequently, the cover member 12 is elevated to the uppermost position by a biasing force of the coil springs 16 or similar elements when going upward while the pressing surface of the pressing member of the robot is in contact with the upper surface of the cover member 12. At that time, contacting portions at tip ends of the pressing members 16A and 16B are rotatably moved approximately at the same time to press the semiconductor device DV toward the contact terminal 20ai.

When the test signal is fed to the input/output section of the printed wiring board 18 while the cover member 12 is being maintained at the uppermost position, the test signal is fed through the contact terminal 20ai to the semiconductor device DV, and, if there is any abnormality in the circuit, an abnormality detection signal issued from the semiconductor device DV is fed to an external fault-diagnosis device through the input/output section.

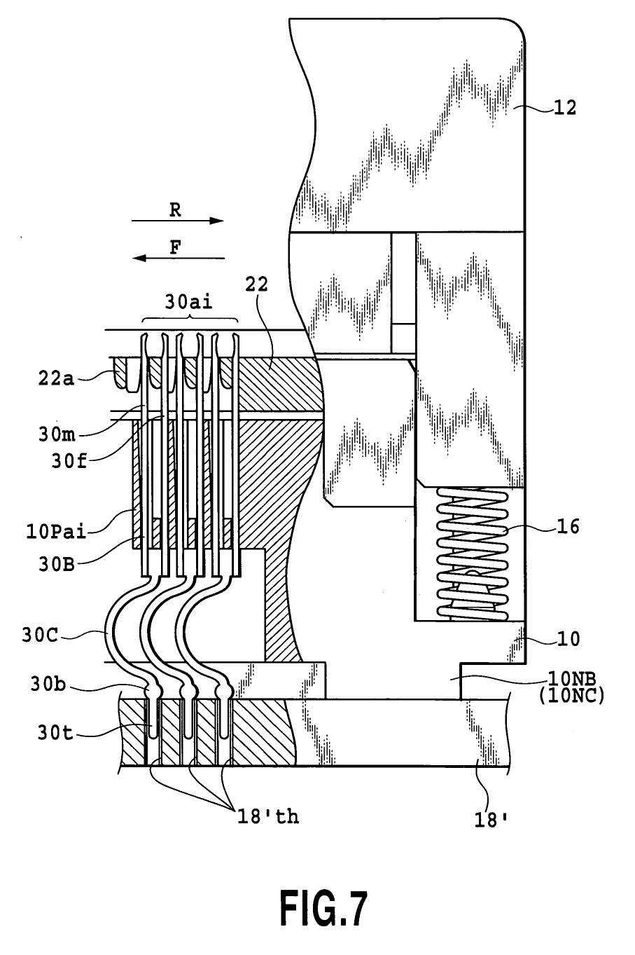

FIG. 7 illustrates another example of a contact terminal together with a printed wiring board used for an embodiment of the semiconductor device socket according to the present invention.

In FIG. 7, the same reference numerals are used for designating the same constituent elements as in the example shown in FIG. 5, and a redundant description is omitted.

The socket bodies 10 are arranged at predetermined positions in a conductive pattern on a printed wiring board 18′. At predetermined positions in the conductive pattern, a plurality of plated through-holes 18′th which receive contact portions 30t of the fixed side terminals 30C of the contact terminals 30ai (i=1 to n, n is a positive integer) are formed lengthwise and crosswise. At four positions on the periphery of a group of the plated through-holes 18′th, there are bores 18a similar to those described previously for fixing the fixing nibs 10NA to 10ND.

The contact terminal 30ai is integrally formed of elastic sheet metal by a pressing operation and extends generally perpendicular to the surface of the printed wiring board 18′. The contact terminal 30ai includes a pair of contacts comprising a movable side contact 30m and a fixed side contact 30f for selectively nipping a spherical electrode of the semiconductor device DV described above, a fixed side terminal 30C having a contact portion 30t to be inserted into the plated through-hole 18′th of the printed wiring board 18′, and a fixed portion 30B for coupling the movable side contact piece 30m and the fixed side contact piece 30f to the fixed side terminal 30C.

In FIG. 7, the movable side contact piece 30m is elastic so as to be close to or spaced away from the fixed side contact piece 30f. At upper ends of the movable side contact piece 30m and the fixed side contact piece 30f, there are contact portions in contact with the spherical electrode of the semiconductor device DV. The respective contact portion projects to a position in the vicinity of the positioning part 14 through the slits 22b of the slider member 22.

Also, in FIG. 7, when the slider member 22 is moved in the direction indicated by an arrow F, the contact portion of the movable side contact piece 30m is pressed by the pressing portion 22a of the slider member 22 to be moved away from the contact portion of the fixed side contact piece 30f. On the other hand, if the slider member 22 is moved in the direction indicated by an arrow R and returns to the initial position from the remote position, the contact portion of the movable side contact piece 30m is closer to the contact portion of the fixed side contact piece 30f.

The arcuate shaped fixed side terminal 30C is elastic and is coupled to the fixed portion 30B at one end thereof, while the contact portion 30t formed at the other end of the fixed side terminal 30C is inserted into the plated through-hole 18′th of the printed wiring board 18′. In the boundary between the arcuate portion of the fixed side terminal 30C and the contact portion 30t, a circular stopper 30b is formed to be brought into contact with the periphery of the open end of the plated through-hole 18′th.

Accordingly, even in this example, the soldering operation of the fixed side terminal 30C of the contact terminal 30ai to the plate through-hole 18′th of the printed wiring board 18′ is unnecessary.

In the above-described example, the embodiment of the present invention is applied to a semiconductor device socket having a construction wherein the contact portion of the movable side contact piece 20m is pressed by the pressing portion 22a of the slider member 22 to be spaced away from the contact portion of the fixed side contact piece 20f when the slider member 22 slid on a flat surface of an upper face of the contact accommodating portion is moved in a predetermined direction. However, the present invention is not so limited, but may be, of course, applied to a semiconductor device socket wherein a moving plate provided with a partitioning wall arranged between a pair of contact pieces is moved vertically relative to the socket body so that a pair of contact pieces are moved apart from each other, for example, as shown in Japanese Patent Laid-Open No. 2004-111215.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A semiconductor device socket comprising:
a socket body having a semiconductor device accommodation part for detachably connecting to the semiconductor device, said socket body provided on a printed wiring board having an electrode surface forming a group of electrodes;
a contact terminal arranged in the semiconductor device accommodation part, having a pair of elastical contact pieces for selectively nipping terminals of the semiconductor device, and a fixed side terminal formed continuous to the contact piece to be elastically deformable in a direction generally perpendicular to the electrode surface of the printed wiring board to touch the electrode surface, said contact terminal electrically connecting the terminal of the semiconductor device to the electrode surface of the printed wiring board;
a slider member having a pressing portion for moving one or both of the contact pieces of said contact terminal so that one of the contact pieces of said contact terminal moves relatively closer or further away from the other contact piece, and
a cover member movably supported by the socket body for operating the pressing portion of said slider member in accordance with attachment/detachment of the semiconductor device relative to the semiconductor device accommodation part so that the pair of contact pieces of said contact terminal is in contact with or spaced away from the terminal of the semiconductor device.

2. The semiconductor device socket as claimed in claim 1, further comprising:
a plurality of locking nibs formed on the bottom of said socket body integrally therewith for locking said socket body to the printed wiring board, each of the locking nibs having a pair of elastically deformable locking pieces configured to engage or disengage said socket body relative to the printed wiring board, and
a screw member for biasing the locking pieces of the locking nibs to the periphery of a locking bore in the printed wiring board.

3. The semiconductor device socket as claimed in claim 2, wherein the locking portion of a pair of bifurcate locking pieces has a slant engageable with the periphery of the locking bore and said screw member is threaded into a conical bore formed between the pair of locking pieces.
